(19) United States
(12) Patent Application Publication
(10) Pub. No.: US 2025/0346693 A1
(43) Pub. Date: Nov. 13, 2025

(54) HIGH-PERFORMANCE ZIEGLER CATALYST FOR LOOP-SLURRY PROCESS

(71) Applicant: Equistar Chemicals, LP, Houston, TX (US)

(72) Inventors: Jonas Alves Fernandes, Cincinnati, OH (US); Ty Martin, Alvin, TX (US); Amber L. Hans, Rosharon, TX (US)

(73) Assignee: Equistar Chemicals, LP, Houston, TX (US)

(21) Appl. No.: 19/201,091

(22) Filed: May 7, 2025

Related U.S. Application Data
(60) Provisional application No. 63/645,232, filed on May 10, 2024.

(51) Int. Cl. C08F 110/02; B01J 27/13; B01J 27/138; B01J 35/70; B01J 37/06

(52) U.S. Cl. CPC C08F 110/02; B01J 27/13; B01J 27/138; B01J 35/70; B01J 37/06; C08F 2410/06; C08F 2500/07; C08F 2500/12; C08F 2500/18; C08F 2500/24

(57) ABSTRACT

A polyethylene composition produced by a loop-slurry process. The process includes contacting a feedstock comprising ethylene with a solid catalyst having a particle size (D₅₀) of about 5 to about 20 micrometers and comprising a magnesium dihalide support containing a predominantly titanium trichloride species on its crystalline lattice derived by the reaction of magnesium alcoholates with tetravalent, halogen-containing compounds and one or more aluminum alkyl or aluminum alkyl halide components at a temperature of between about 90 to about 105° C. and a residence time of between about 30 to about 60 min. The resulting polyethylene composition has a particle size (D₅₀) of about 200 to 400 micrometers, with less than 0.05 wt. % of particles being less than 45 micrometers in diameter. A loop-slurry process and a catalyst component are also provided.

### PRIOR RELATED APPLICATION

This application claims the benefit of priority to U.S. Provisional Application No. 63/645,232, filed on May 10, 2024, which is incorporated here by reference in its entirety.

### FIELD OF THE INVENTION

The present disclosure is directed generally to high-performance catalysts for use in the production of polyethylene. More particularly, a high-performance catalyst is used in a loop-slurry process to produce high-density polyethylene homopolymers and copolymers.

### BACKGROUND OF THE INVENTION

Interest in catalysis continues to grow in the polyolefin industry. Many olefin polymerization catalysts are known, including conventional Ziegler catalysts. Known processes to polymerize olefins include solution, slurry, and gas-phase processes. As end-use applications become more demanding, there is an increased incentive to improve polyolefin properties by catalyst technology and process improvements.

One type of Ziegler catalyst that has high efficiency uses a magnesium-containing polysiloxane support (see U.S. Pat. Nos. 4,511,669, 4,518,706 and WO 95/06672). The catalyst can be prepared by reacting hydropolysiloxane with a dialkyl magnesium compound and contacting the reaction product with a transition metal alkoxide. This mixture is then reacted with a halogenating agent, such as a dialkyl aluminum chloride or an alkyl aluminum dichloride. Altering the halogen to magnesium ratio influences the molecular weight distribution of the polymer.

The Ziegler catalysts described therein are effective for solution polymerizations. For slurry processes, however, a balance must be struck between polyolefin particle size and catalyst efficiency. As efficiency increases, polyolefin bulk density decreases. Thus, the catalysts cannot be used in some slurry processes because fine particles of polyolefin are produced. Also, the catalysts are generally not useful in gas-phase polymerizations.

Therefore, what is needed are improved Ziegler catalysts for loop-slurry polymerization that produce polyethylene having improved properties, including HDPE for applications such as injection molding.

### SUMMARY OF THE INVENTION

The present disclosure is directed to the use of Ziegler catalysts having a particle size (D₅₀) between 5-20 micrometers in a loop-slurry polymerization reactor to produce polyethylene that has a density from about 0.930 g/cm³ to about 0.970 g/cm³ (ASTM D1505), a melt flow rate from about greater than 0 to about 50 g/10 min (2.16 kg, 190° C.), a particle size distribution from about 50 to about 850 micrometers in diameter, wherein less than about 0.05 wt. % of the particles are 850 micrometers or larger and/or less than about 0.05 wt. % of the particles are 45 micrometers or less, and a D₅₀ of about 200 to 400 micrometers. In some embodiments, the produced polyethylene has a comonomer incorporation between greater than 0 and 5 butyl branches per 1000 carbons, and 0 for a homopolymer. In other embodiments, the produced polyethylene has a Mn range between 5 and 25 kg/mol, a Mw between 50 and 120 kg/mol, a M_{z} between 200 and 500kg/mol, a molecular weight distribution (Mw/Mn) between 3 and 8, and a Mz/Mw range between 3 and 5. In some embodiments, the produced polyethylene has a Mn range between 10 and 20 kg/mol, a Mw between 50 and 100 kg/mol, a Mz between 200 and 500 kg/mol, a Mw/Mn between 4 and 6, and a Mz/Mw range between 3 and 5. In other embodiments, the polyethylene has a poured powder bulk density (PBD) of at least 0.35 g/cm³, or a PBD of at least 0.40 g/cm³.

In some embodiments, the catalyst mileage for the Ziegler catalyst is greater than 10 kg of PE per g of catalyst (catalyst D₅₀ particle size between 5 and 20 micrometer and obtained powder bulk density greater than 0.370 g/cm³) in the loop-slurry reactor. In other embodiments, the reactor composition has an ethylene mol % that is greater than 2 mol % and a diluent that is isobutane or propane.

In one aspect, provided is a polyethylene composition produced by a loop-slurry process. The process includes contacting a feedstock comprising ethylene with a solid catalyst comprising a magnesium dihalide support containing a predominantly titanium trichloride species on its crystalline lattice derived by the reaction of magnesium alcoholates with tetravalent, halogen-containing compounds and one or more aluminum alkyl or aluminum alkyl halide components at a temperature of between about 90 to about 105° C. and a residence time of between about 30 to about 60 min. The polyethylene composition has one or more of the following properties:
(a) density from about 0.940 g/cm³ to about 0.970 g/cm³;
(b) a melt flow rate from greater than 0 to about 50 g/10 min;
(c) a particle size distribution of 50 to 850 micrometers,
(d) a particle size distribution having less than 0.05 wt. % of the particles are 850 micrometers in diameter or larger and/or having less than 0.05 wt. % of the particles are less than 45 micrometers in diameters;
(e) a comonomer incorporation between 0 and 5 butyl branches per 1000 carbons;
(f) a Mn range between 5 and 25 kg/mol;
(g) a M_{w} between 50 and 120 kg/mol;
(h) an M_{z} between 200 and 500 kg/mol;
(i) a M_{w}/Mₙ between 3 and 8;
(j) a M_{z}/M_{w} range between 3 and 5;
(k) a D₅₀ between 200 and 400 micrometers; or,
(l) poured powder bulk density (PBD) of at least 0.35 g/cm³.

In one aspect, provided is a polyethylene composition that has less than 0.05 wt. % of fine particles (diameters of less than 45 micrometers), wherein the polyethylene composition has a degree of branching of less than 5 butyl branches (from 1-hexene comonomer) per 1000 carbon.

In another aspect, provided is a loop-slurry process for producing a polyethylene copolymer. The process includes contacting a feedstock comprising ethylene and a comonomer with a solid catalyst comprising a magnesium dihalide support containing a predominantly titanium trichloride species on its crystalline lattice derived by the reaction of magnesium alcoholates with tetravalent, halogen-containing compounds and one or more aluminum alkyl or aluminum alkyl halide components at a temperature of between about 90 to about 105° C. and a residence time of between about 30 to about 60 min. Suitable comonomers for the polyethylene copolymer include alpha-olefins from 3 to 10 carbons atoms, preferably 1-hexene or 1-butene.

In any of the above polyethylene compositions or processes, a catalyst component is obtained by a process comprising: reacting in an inert hydrocarbon suspension medium a Mg(OR₁)(OR₂) compound, in which R₁ and R₂ are identical or different and are each an alkyl radical having 1 to 10 carbon atoms, with a tetravalent transition metal compound having at least a metal-halogen bond, used in amounts such that the molar ratio metal/Mg is from 0.05 to 5, thereby obtaining a solid reaction product dispersed in a hydrocarbon slurry; washing the solid reaction product dispersed in a hydrocarbon slurry with a liquid hydrocarbon; contacting the washed solid reaction product obtained with a tetravalent titanium compound; and contacting the product obtained with an organometallic compound of a metal of group 1, 2 or 13 of the Periodic Table.

In any of the above polyethylene compositions or processes, the Mg(OR₁)(OR₂) compound is magnesium ethylate.

In any of the above polyethylene compositions or processes, the transition metal compound is MXₘ(OR₄)₄₋ₘ, wherein M is titanium, R₄ is an alkyl radical having from 1 to 9 carbon atoms, X is a halogen atom, and m is from 1 to 4.

In any of the above polyethylene compositions or processes, the reaction of magnesium alkoxide with the tetravalent transition metal compounds is carried out at a temperature from 50 to 140° C.

In any of the above polyethylene compositions or processes, the tetravalent titanium compound has the formula TiXₘ(OR₄)₄₋ₘ, wherein R₄ is an alkyl radical having from 1 to 9 carbon atoms, X is a halogen atom, and m is from 1 to 4.

In any of the above polyethylene compositions or processes, the tetravalent titanium compound is contacted in a molar ratio of Ti/Mg ranging from 0.001 to 1.

In any of the above polyethylene compositions or processes, the tetravalent transition metal compound used above is TiCl₄.

In any of the above polyethylene compositions or processes, the solid reaction product is contacted with an organometallic compound chosen among organoaluminum compounds.

In any of the above polyethylene compositions or processes, the organoaluminium compounds are chloride-containing organoaluminum compounds.

In any of the above polyethylene compositions or processes, the solid catalyst component is contacted with a silicon compound of formula R^{I}ₐR^{II}_{b}Si(OR^{III})_{4-(a+b)} where R^{I}-R^{III} are linear, branched, cyclic or aromatic C₁-C₂₀ hydrocarbon groups, a and b are integers from 0 to 2 with the proviso that (a+b) ranges from 1 to 3.

In any of the above processes, wherein the grain size of the catalyst is between 5 and 15 micrometers.

In any of the above processes, wherein the operating temperature is between 90 and 100° C.

In any of the above polyethylene compositions or processes, the polyethylene composition is a high-density polyethylene (HDPE) for use in injection molding. The HDPE used for injection molding can have at least of the following properties:
(a) density from about 0.940 g/cm³ to about 0.970 g/cm³;
(b) a melt flow rate from about 1 to about 25 g/min;
(c) a particle size distribution between 50 to 850 micrometers, wherein less than 0.04 wt. % of the particles are 850 micrometers or larger and/or less than 0.05 wt % of fine particles (i.e. particles with size inferior of 45 micrometers);
(d) a Mn range between 5 and 25 kg/mol;
(e) a M_{w} between 50 and 120 kg/mol;
(f) an M_{z} between 200 and 500 kg/mol;
(g) a M_{w}/Mₙ between 3 and 8; and/or,
(h) a M_{z}/M_{w} range between 3 and 5.

In any of the above polyethylene compositions or processes, the polyethylene composition is a high-density polyethylene (HDPE) for use in production of crates, pallets, totes, tubs, pails, lawn and garden tools, recreation vehicles parts, irrigation systems, industrial application parts, containers, closures, houseware and toys.

The foregoing has outlined rather broadly the features and technical advantages of the present invention in order that the detailed description of the invention that follows may be better understood. Additional features and advantages of the invention will be described hereinafter, which form the subject matter of the claims of the invention. It should be appreciated by those skilled in the art that the conception and specific embodiments disclosed may be readily utilized as a basis for modifying or designing other polyolefins, catalysts, and/or processes for carrying out the same purposes of the present invention. It should also be realized by those skilled in the art that such equivalent constructions do not depart from the spirit and scope of the invention as set forth in the appended claims. The novel features which are believed to be characteristic of the invention, both as to its structure and method of manufacture, together with further objects and advantages will be better understood from the following description.

### BRIEF DESCRIPTION OF THE DRAWINGS

FIG. 1 presents a plot indicating the stable catalyst kinetics during ethylene polymerization in presence of 1-hexene as comonomer in a semi-batch reactor.

FIG. 2 presents a plot of hydrogen response for a catalyst as disclosed herein in a loop-slurry process, for an illustrative, non-exclusive example, according to the present disclosure.

FIG. 3 presents a plot of 1-hexene response for a catalyst as disclosed herein in a loop-slurry process, for an illustrative, non-exclusive example, according to one form of the present disclosure.

FIG. 4 presents a plot showing 1-butene vs. 1-hexene response for such catalyst as disclosed herein in two reactors in series of a continuously stir tank reactor (CSTR).

FIG. 5 presents a plot showing 1-butene vs. 1-hexene response for a catalyst as disclosed herein in a CSTR and a loop-slurry process for an illustrative, non-exclusive example, according to another form of the present disclosure.

FIG. 6 presents scanning electron microscope (SEM) images of Products 1 and 4.

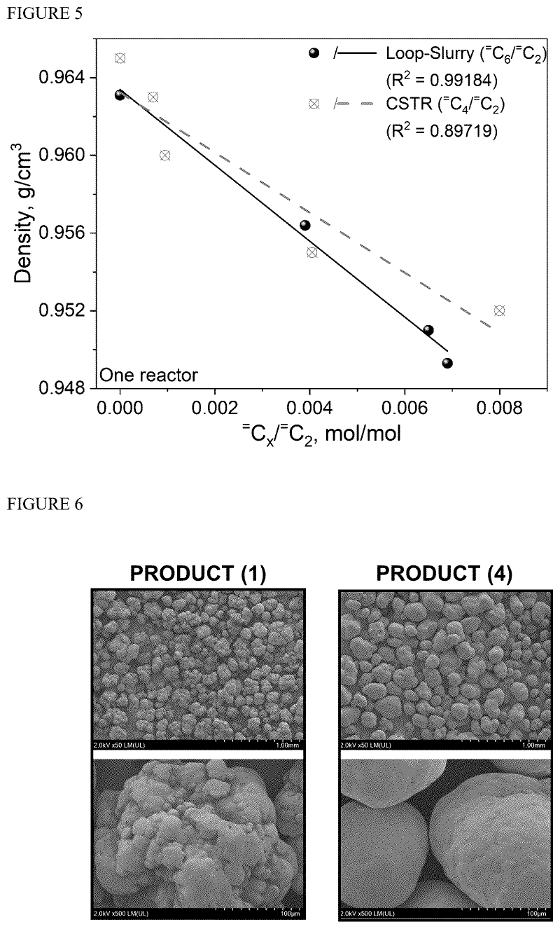

FIGS. 1-6 provide illustrative, non-exclusive examples of methods and systems for forming polymeric products according to the present disclosure and/or of systems, apparatus, and/or assemblies that may include, be associated with, be operatively attached to, and/or utilize such systems. In FIGS. 1-6, like numerals denote like, or similar, structures and/or features; and each of the illustrated structures and/or features may not be discussed in detail herein with reference to each of FIGS. 1-6. Similarly, each structure and/or feature may not be explicitly labeled in each of FIGS. 1-6; and any structure and/or feature that is discussed herein with reference to any one of FIGS. 1-6 may be utilized without departing from the scope of the present disclosure.

In general, structures and/or features that are, or are likely to be, included in a given form are indicated in solid lines, while optional structures and/or features are indicated in broken lines. However, a given form is not required to include all structures and/or features that are illustrated in solid lines therein, and any suitable number of such structures and/or features may be omitted from a given form without departing from the scope of the present disclosure.

While the disclosed process and composition are susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DEFINITIONS

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than the broadest meaning understood by skilled artisans, such a special or clarifying definition will be expressly set forth in the specification in a definitional manner that provides the special or clarifying definition for the term or phrase. It must also be noted that, as used in the specification and the appended claims, the singular forms “a,” “an,” and “the” include plural references unless otherwise specified.

For example, the following discussion contains a non-exhaustive list of definitions of several specific terms used in this disclosure (other terms may be defined or clarified in a definitional manner elsewhere herein). These definitions are intended to clarify the meanings of the terms used herein. It is believed that the terms are used in a manner consistent with their ordinary meaning, but the definitions are nonetheless specified here for clarity.

The expressions “polyethylene composition”, “polyethylene”, “ethylene polymer”, and related terms are intended to embrace, as alternatives, both a single ethylene polymer and an ethylene polymer composition. The ethylene polymer can be a homopolymer or a copolymer, or combinations thereof.

As used herein, the term “copolymer” refers to a polyolefin that contains ethylene monomer units and at least one alpha-olefin monomer unit. As used herein, the term “α-olefin” or “alpha-olefin” means an olefin of the general formula CH₂═CH—R, wherein R is a linear or branched alkyl containing from 1 to 10 carbon atoms. The α-olefin can be selected, for example, from 1-butene, 1-pentene, 1-hexene, 4-methyl-1-pentene, 1-octene, and the like.

As used herein, the terms “comonomer” or “comonomers” refers to the type or types of monomers that are the minor components in the polymer chain.

The term “D₅₀” refers to the particle size of the median diameter or the median particle size. Polymer and catalyst particle size and particle size distribution were obtained by small-angle static light scattering (SASLS) instrument, Mastersizer 3000 by Malvern Panalytical. Other parameters can also be obtained, such as: (a) D₁₀ particle size at which 10% of the particles in the samples are smaller than the given size and (b) D₉₀ particle size at which 90% of the particles in the samples are smaller than the given size. Furthermore, the particle size span can also be determined by the equation (D₉₀−D₁₀)/D₅₀ to provide a distribution width of the sample.

The terms “high-density polyethylene” or “HDPE” are used interchangeably to mean ethylene homopolymers and ethylene copolymers produced in a gas phase and/or slurry phase polymerization and having a density in the range of 0.940 g/cm³ to 0.970 g/cm³.

“Processability,” as used herein, refers to how well a polymer composition can be formed into a cast of blown film of commercial quality or molded by injection or compression molding into a molded article of commercial quality at commercially acceptable rates using the equipment and conditions.

The term “pure” as used in reference to the feed stream refers to a feed that is 100% olefin, but does not mean that the feed contains only one type of olefin. Rather, a “pure” feed stream can have a mixture of olefins such as those with 2 to 10 carbons, and combinations thereof.

The terms “polyolefin-based” and “polyolefin-rich”, in reference to materials, feed streams, or waste streams, are used interchangeably to refer to a mixture that is at least 80% polyolefin.

The terms “melt flow rate” or “MFR” are used interchangeably to refer to the measure of the ability of the melt of the base resin to flow under pressure. The melt flow rate is determined according to ASTMD1238 unless otherwise noted, at a 2.16 kg of weight and a temperature of 190° C. The melt flow rate by ASTM D1238 can also be measured at high load of 21.6 kg of weight at a temperature of 190° C. As a result, the Flow Rate Ratio (FRR) of the polymer sample can be determined to correlate with the width of the molecular weight distribution by dividing the MFR at the higher test load by the MFR at the lowest test load.

The term “molecular weight distribution” (MWD), which is also called M_{w}/Mₙ, is used herein to describe the breadth of different-chain-length molecules in a polymer. MWD is often used to indicate the processability and properties of polymers, with a wider MWD indicating a more easy-to-process resin under most conditions. Polydispersity index (PI) is strictly correlated with the MWD of the polymer. PI is obtained from the ratio between weight average molecular weight (M_{w}) and the number average molecular weight (Mₙ) obtained by high temperature Polymer Char gel permeation chromatography (“GPC”), also referred to as high temperature size exclusion chromatography (HT-SEC), equipped with a filter-based infrared detector, IR5, a four-capillary differential bridge viscometer, and a Wyatt 18-angle light scattering detector. Higher average molecular weight (M_{z}) is also obtained by HT-SEC and it provides an important dimension of the high molecular weight polymer chains.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the disclosure.

All concentrations herein are by weight percent (“wt. %”) unless otherwise specified.

The use of the word “a” or “an” when used in conjunction with the term “comprising” in the claims or the specification means one or more than one unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive. Further, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one form, to A only (optionally including entities other than B); in another form, to B only (optionally including entities other than A); in yet another form, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one form, to at least one, optionally including more than one, A, with no B present (and optionally including entities other than B); in another form, to at least one, optionally including more than one, B, with no A present (and optionally including entities other than A); in yet another form, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

The terms “comprise”, “have”, “include” and “contain” (and their variants) are open-ended linking verbs and allow the addition of other elements when used in a claim.

The phrase “consisting of” is closed and excludes all additional elements.

The phrase “consisting essentially of” excludes additional material elements but allows the inclusions of non-material elements that do not substantially change the nature of the invention.

The phrase “substantially all of” means greater than or equal to 95 wt. %, greater than or equal to 99 wt. %, greater than or equal to 99.5 wt. %, or greater than or equal to 99.9 wt. %.

### DETAILED DESCRIPTION OF THE INVENTION

Illustrative embodiments of the subject matter claimed below will now be disclosed. In the interest of clarity, some features of some actual implementations may not be described in this specification. It will be appreciated that in the development of any such actual embodiments, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Described herein is a method of preparing polyethylene (both homo- and copolymers) using a Ziegler catalyst system in a loop-slurry system, wherein the polyethylene has a particle size distribution from about 50 to about 850 micrometers. The polyethylene's particle distribution may also have less than 0.05 wt. % of particles having a diameter of 850 micrometers or greater, or less than 0.05 wt. % of fines or particles with a diameter less than 45 micrometers, as measured by ASTM D1921-01. The particle size (D₅₀), also called the grain size, of the Ziegler catalyst is about 5 to 20 micrometers.

Polymerization Reactor: As is known, loop reactors generally include a circulating pump partially disposed to circulate a process stream therethrough. At least a portion of the circulating pump is disposed within the loop reactor via an aperture formed therethrough. Seals are usually employed to prevent the passage of the process stream through any portion of the aperture.

Although not shown herein, the process stream flow may be modified based on unit optimization. For example, at least a portion of any fraction may be recycled as input to any other system within the process. Also, additional process equipment, such as heat exchangers, may be employed throughout the processes described herein and such placement is generally known to one skilled in the art. Further, while described below in terms of primary components, the streams indicated below may include any additional components as known to one skilled in the art.

Various forms disclosed herein generally include circulating a process stream within a loop reactor. It is contemplated that various forms described in further detail below may be used in any loop reactor system. In specific form, the loop reactor is used to form a polymer. For example, the loop reactor may be used to form a polyolefin, such as polyethylene.

Slurry phase processes generally include forming a suspension of solid, particulate polymer in a liquid polymerization medium, to which monomers and optionally hydrogen, along with catalyst and co-catalyst, are added. The suspension, which may include diluents, may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., n-propane or isobutane), for example. The medium employed is generally liquid under the conditions of polymerization and relatively inert. A bulk phase process is similar to that of a slurry process. However, a process may be a bulk process, a slurry process, or a bulk slurry process, for example.

In a specific form, a slurry process or a bulk process may be carried out continuously in one or more loop reactors. A catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer.

In the present disclosure, the loop-slurry reactor has a temperature of from about 90° C. to about 105° C., or from about 92° C. to 98° C. Reaction heat may be removed through the loop wall via any method known to one skilled in the art, such as via a double-jacketed pipe, for example. The reaction residence time to prepare the presently disclosed polyethylene is between about 30 and about 60 min.

In some embodiments, the feedstock in the loop-slurry reactor is polyolefin-based or 100% polyolefin. Alternatively, the feedstock in the loop-slurry reactor is ethylene-based. In other embodiments, the feedstock has ethylene and one or more co-monomers. Suitable comonomers for a polyethylene copolymer include alpha-olefins with from 3 to 10 carbons, preferably 1-octene, 1-hexene or 1-butene. The comonomer(s) may make up between 0.001 and 0.1 mol % of the feedstock.

Catalyst: Catalyst systems useful for polymerizing olefin monomers generally include Ziegler catalyst systems. Surprisingly, a Ziegler catalyst system that has found great utility in continuously stirred tank reactors (CSTR) has been found to produce excellent results in loop-slurry reactors. As is known, Ziegler catalysts are generally formed from the combination of a metal component (e.g., a catalyst) with one or more additional components, such as a catalyst support, a cocatalyst and/or one or more electron donors, for example.

In particular, the present disclosure relates to catalyst components for the polymerization of olefins CH₂═CHR, wherein R is hydrogen or hydrocarbon radical having 1-12 carbon. The disclosure relates to catalyst components suitable for the preparation of homopolymers and copolymers of ethylene and to the catalysts obtained therefrom, wherein the grain size of the catalyst is from 5 to 20 micrometers.

Specifically, the present disclosure relates to solid catalyst components, comprising titanium magnesium and halogen, and obtainable by a specified sequence of reaction steps.

The catalysts of the disclosure are suitably used in (co)polymerization processes of ethylene to prepare (co)polymers having medium-narrow polydispersity index (PI) and high activity. The PI is one of the important characteristics of ethylene polymers in that it affects both the rheological behavior, and therefore the processability, and the final mechanical properties. In particular, polymers with narrow PI are suitable for cast films and injection molding in that deformation and shrinkage problems in the manufactured article are minimized. The width of the molecular weight distribution for the ethylene polymers is generally expressed as the flow rate ratio FRR_{21.6/2.16}. FRR_{21.6/2.16} is the ratio between the melt flow rate measured by a load of 21.6 Kg and that measured with a load of 2.16 Kg. The measurements of melt flow rate are carried out at 190° C.

Catalyst components having the capability of giving polymers with narrow molecular weight distribution are also useful to prepare polymer compositions with broad molecular weight distribution. In fact, one of the most common methods for preparing broad PI polymers is the multi-step process based on the production of different molecular weight polymer fractions in each step, sequentially forming macromolecules. The control of the molecular weight obtained in each step can be carried out according to different methods, for example by varying the polymerization conditions or the catalyst system in each step, or by using a molecular weight regulator. Regulation with hydrogen is a method which finds utility in industrial plants. It has been observed that final compositions of optimal properties are obtainable when a catalyst is used able to provide polymers with narrow PI and different number and weight average molecular weights in each single step that, when combined together form final compositions with broad molecular weight distribution. In these multistep processes a critical step is that in which the average molecular weight polymer fractions can be modulated. In fact, one of important features that the catalyst should possess is the so called “hydrogen response,” that is the extent of capability to reduce the molecular weight of polymer produced in respect of increasing hydrogen concentration. Higher hydrogen response means that a lower amount of hydrogen is required to produce a polymer with a certain molecular weight. In turn, a catalyst with good hydrogen response would also usually display a higher activity in ethylene polymerization due to the fact that hydrogen has a depressive effect on the catalyst activity. Moreover, it is also important that the polymer chains show a limited amount of long chain branching which in certain applications are responsible for lowering certain properties like impact strength and ESCR.

Additionally, catalyst having the capability of giving polymers with a small particle sizes range and reduced number of fines is desirable. Smaller particle sizes allow the powder polymer to dry well and degas faster, post-reactor. Further, smaller particles also mix more thoroughly in an extruder as its easier for them to be made molten. The reduction of particles that are less than 45 micrometers in diameter, also called “fines”, is desirable because minimize particle carry over with recycle streams and reduce static issues while conveying polymer particles.

In view of the above, it would be therefore useful to have a catalyst component able to provide ethylene polymers with narrow molecular weight distribution and desired particle sizes, combined with a good balance of polymerization activity, and morphological stability.

A catalyst component for use in ethylene (co)polymerization is described in the WO 03/099882. It concerns polymerizing in the presence of a catalyst consisting of the product of the reaction of a gelatinous dispersion of magnesium alkoxide with a transition-metal compound (component a) and an organometallic compound (component b). The reaction between the gelatinous dispersion of magnesium alkoxide and the transition metal compound for the formation of component (a) is carried out in the liquid hydrocarbon phase. The so obtained reaction mixture is then directly reacted with the organoaluminum compound (b) without any intermediate treatment. Although showing properties of interest, the catalyst did not produce sufficiently high polymerization activity and sufficiently narrow molecular weight distribution. In principle, narrowing of MWD could be obtained by using certain oxygenated electron donor compounds. However, this usually involves a reduced polymerization activity of the catalyst. In the case of the catalysts disclosed in WO 03/099882, the contents of which are hereby incorporated by reference in their entirety, the activity is already not particularly high, thus the use of an electron donor for narrowing MWD would involve too low activity for operation in an industrial plant.

It has now surprisingly been discovered that by modifying the catalyst preparation recipe disclosed in the prior art and using it under certain loop-slurry reactor conditions, it is possible to greatly improve its polymerization activity making it suitable also for the use in combination with an electron donor. Therefore, it is an object of the present disclosure to produce a catalyst component for the polymerization of olefins obtained by a process comprising:
(a) reacting in an inert hydrocarbon suspension medium a Mg(OR₁)(OR₂) compound, in which R₁ and R₂ are identical or different and are each an alkyl radical having 1 to 10 carbon atoms, with a tetravalent transition metal compound having at least a Metal-halogen bond, used in amounts such that the molar ratio metal/Mg is from 0.05 to 10, thereby obtaining a solid reaction product dispersed in a hydrocarbon slurry,
(b) washing the solid reaction product dispersed in a hydrocarbon slurry with a liquid hydrocarbon,
(c) contacting the washed solid reaction product obtained in (b) with a tetravalent titanium compound, and
(d) contacting the product obtained in (c) with an organometallic compound of a metal of group 1, 2 or 13 of the Periodic Table.

In step (a) of the preparation of the catalyst component, R₁ and R₂ are alkyl groups having from 2 to 10 carbon atoms or a radical —(CH₂)ₙOR₃, where R₃ is a C₁-C₄-alkyl radical, and n is an integer from 2 to 6. In one form, R₁ and R₂ are C₁-C₂-alkyl radical. Examples of such magnesium alkoxides are: magnesium dimethoxide, magnesium diethoxide, magnesium di-i-propoxide, magnesium di-n-propoxide, magnesium di-n-butoxide, magnesium methoxide ethoxide, magnesium ethoxide n-propoxide, magnesium di(2-methyl-1-pentoxide), magnesium di(2-methyl-1-hexoxide), magnesium di(2-methyl-1-heptoxide), magnesium di(2-ethyl-1-pentoxide), magnesium di(2-ethyl-1-hexoxide), magnesium di(2-ethyl-1-heptoxide), magnesium di(2-propyl-1-heptoxide), magnesium di(2-methoxy-1-ethoxide), magnesium di(3-methoxy-1-propoxide), magnesium di(4-methoxy-1-butoxide), magnesium di(6-methoxy-1-hexoxide), magnesium di(2-ethoxy-1-ethoxide), magnesium di(3-ethoxy-1-propoxide), magnesium di(4-ethoxy-1-butoxide), magnesium di(6-ethoxy-1-hexoxide), magnesium dipentoxide, magnesium dihexoxide. One may use the simple magnesium alkoxides such as magnesium diethoxide, magnesium di-n-propoxide and magnesium di-i-butoxide. Magnesium diethoxide is an example of one. It can be used as a suspension or as a gelatineous dispersion. The suspension or the gel can be prepared starting from commercially available Mg(OC₂H₅)₂ usually having average particle diameter ranging from 200 to 1200 micrometers or from 500 to 800 micrometers.

Before the reaction with the transition metal halide the magnesium alcoholate is suspended in an inert, saturated hydrocarbon. In order to lowering the magnesium alcoholate particle size, the suspension can be subject to high shear stress conditions by means of a high-speed disperser (for example Ultra-Turrax or Dispax, IKA-Maschinenbau Janke & Kunkel GmbH) working under inert atmosphere (Ar or N₂). The shear stress is applied until a gel-like dispersion is obtained. This dispersion differs from a standard suspension in that it is substantially more viscous than the suspension and is gel-like. Compared with the suspended magnesium alcoholate, the dispersed magnesium alcoholate settles out much more slowly and to a far lesser extent.

The magnesium alkoxide is firstly reacted with the tetravalent transition metal compound of the formula (II)

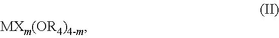

where M is titanium, zirconium, or hafnium, or titanium or zirconium, or titanium, R₄ is an alkyl radical having from 1 to 9, or from 1 to 4 carbon atoms and X is a halogen atom, or chlorine, and m is from 1 to 4, or from 2 to 4.

Examples which may be mentioned are: TiCl₄, TiCl₃(OC₂H₅), TiCl₂(OC₂H₅)₂, TiCl(OC₂H₅)₃, TiCl₃(OC₃H₇), TiCl₂(OC₃H₇)₂, TiCl(OC₃H₇)₃, TiCl₃OC₄H₉), TiCl₂(OC₄H₉)₂, TiCl(OC₄H₉)₃, TiCl₃(OC₆H₁₃), TiCl₂(OC₆H₁₃)₂, TiCl(OC₆H₁₃)₃, ZrCl₄, preference is given to using TiCl₄ or ZrCl₄. Particular preference is given to TiCl₄.

The reaction of the magnesium alkoxide with the tetravalent transition metal compounds is carried out at a temperature at from 50 to 140° C., or from 60 to 120° C., or from 70 to 90° C. over a period of from 0.1 to 20 hours, or within 1 to 10 hours, or within 1 to 7 hours. Suitable inert hydrocarbon suspension media for the abovementioned reactions include aliphatic and cycloaliphatic hydrocarbons such as butane, pentane, hexane, heptane, cyclohexane, isooctane, and also aromatic hydrocarbons such as benzene and xylene. Petroleum spirit and hydrogenated diesel oil fractions which have carefully been freed of oxygen, sulfur compounds and moisture can also be used.

The magnesium alkoxide and the tetravalent transition metal compound can be reacted in a molar ratio of Metal/Mg ranging from 0.05 to 5, or from 0.1 to 1. At the end of the reaction a solid product is obtained by removing the liquid phase.

In step (b) one or more washing steps with inert hydrocarbon are carried out until the supernatant mother liquor has Cl and Ti concentrations of less than 10 mmol/L. The washing step can be carried out with the same hydrocarbon medium used in step (a) at a temperature ranging from 10° C. to the boiling point of the medium used. It is carried out under mild conditions or at room temperature when working at Ti/Mg molar ratios in the range of 0.1 to 1. Washings at higher temperature are suitable for higher Ti/Mg molar ratios.

After washing the solid product coming from (b), or still in form of a concentrated slurry, is contacted in step (c) with a tetravalent titanium compound of formula TiXₘ(OR₄)₄₋ₘ where X and m have the same meaning disclosed above. Titanium compounds are TiCl₄, TiCl₃(OC₂H₅), TiCl₂(OC₂H₅)₂, TiCl(OC₂H₅)₃, TiCl₃(OC₃H₇), TiCl₂(OC₃H₇)₂, TiCl(OC₃H₇)₃, TiCl₃OC₄H₉), TiCl₂(OC₄H₉)₂, TiCl(OC₄H₉)₃, TiCl₃(OC₆H₁₃), TiCl₂(OC₆H₁₃)₂, TiCl(OC₆H₁₃)₃, TiCl₄ may be advantageously employed.

The product coming from (b), and the tetravalent transition metal compound can be contacted in a molar ratio of Ti/Mg ranging from 0.001 to 1, or from 0.01 to 0.1. At the end of the reaction a solid product is obtained by totally or partially removing the liquid phase.

In the subsequent step (d), an organometallic compound of a metal of group 1, 2 or 13 of the Periodic Table is reacted with the solid reaction product of step (c). The organometallic compound is chosen among organoaluminum compounds. Suitable organoaluminum compounds are chlorine-containing organoaluminum compounds, e.g. dialkylaluminum monochlorides of the formula

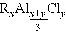

or alkylaluminum sesquichlorides of the formula R₃Al₂Cl₃, where R₃ is an alkyl radical having from 1 to 16 carbon atoms. Examples which may be mentioned are (C₂H₅)₂AlCl, (iC₄H₉)₂AlCl, (C₂H₅)₃Al₂Cl₃. It is also possible to use mixtures of these compounds.

The organoaluminum compound can be added in a molar ration of 0.1 to 2, or from 0.3 to 1 with respect to magnesium alkoxide. The reaction is carried out in suspension under stirring at a temperature ranging from 0 to 150° C., or from 60 to 120° C. within 0.5 to 7 hours, or from 1 to 5 hours.

At the end of the preparation process, the particle size D₅₀ or medium of the catalyst component (component A) ranges from 5 to 20 micrometers.

As already explained the catalyst component obtained with this process is endowed with such a high activity that makes it possible for it to also incorporate an electron donor for the narrowing of the molecular weight distribution of the polymer while maintaining an activity of industrial interest.

The electron donor is selected from oxygenated compounds belonging to ethers, esters, alcohols, aldehydes, alkoxysilanes, and ketones.

Of particular value are the silicon compounds of formula R^{I}aR^{II}_{b}Si(OR^{III})_{4-(a+b)} where R^{I}-R^{II} are linear, branched, cyclic or aromatic C₁-C₂₀ hydrocarbon groups a and b are integers from 0 to 2 with the proviso that (a+b) ranges from 1 to 3.

R^{III} may be a linear C₁-C₅ alkyl, or methyl or ethyl. In this connection, when b is 0, R^{I} is a linear, branched, or cyclic alkyl radical or an aryl radical having from 3 to 10 carbon atoms and a is 1. In this form, R^{I} is selected from propyl, isopropyl, isobutyl, cyclopentyl, and phenyl.

According to another form, a and b are 1, R^{I} is selected from C₃-C₁₀ cycloalkyl or aryl groups, R^{II} is selected from linear C₁-C₅ alkyl groups and R^{III} is a linear C₁-C₅ alkyl, or methyl or ethyl.

Non limiting exemplary silicon compounds include diethyldimethoxysilane, dipropyldimethoxysilane, diisopropyldimethoxysilane, dibutyldimethoxysilane, diisobutyldimethoxysilane, isobutylmethyldimethoxysilane, isopropylisobutyldimethoxysilane, dicyclopentyldimethoxysilane, cyclohexylmethyldimethoxysilane, diphenyldimethoxysilane, propyltrimethoxysilane, isopropyltrimethoxysilane, butyltrimethoxysilane isobutyltrimethoxysilane, cyclopentyltrimethoxysilane, phenyltrimethoxysilane, diethyldiethoxysilane, dipropyldiethoxysilane, diisopropyldiethoxysilane, dibutyldiethoxysilane, diisobutyldiethoxysilane, isobutylmethyldiethoxysilane, isopropylisobutyldimethoxysilane, dicyclopentyldiethoxysilane, cyclohexylmethyldiethoxysilane, diphenyldiethoxysilane, propyltriethoxysilane, isopropyltriethoxysilane, butyltriethoxysilane isobutyltriethoxysilane, cyclopentyltriethoxysilane, phenyltriethoxysilane. Preference is given to the group of diethoxysilanes. Compounds may be selected from a group of triethoxysilanes. The electron donor can be used in any of the steps (a), (c) or (d). It is used after completion of step (d) by combining the solid catalyst component with the silicon compound of formula R^{I}aR^{II}_{b}Si(OR^{III})_{4-(a+b)} reported above. The aforementioned silicon compound can be added in a molar ratio of 0.1 to 3, or from 0.3 to 1 with respect to transition metal fixed on the solid component after the reaction with magnesium alkoxide. The reaction is carried out in suspension under stirring at a temperature ranging from 0 to 150° C., or from 60 to 120° C. within 0.5 to 5 hours, or from 1 to 2 hours.

The catalyst component of the disclosure can be converted into active catalyst system by reacting it with a trialkylaluminum (component B) having from 1 to 6 carbon atoms in the alkyl radical, e.g. triethylaluminum, triisobutylaluminum, triisohexylaluminum, Preference is given to triethylaluminum and triisobutylaluminum.

The mixing of the component (A) and the component (B) can be carried out in a stirred vessel at a temperature of from −30° C. to 150° C. prior to the polymerization. It is also possible to combine the two components directly in the polymerization vessel at a polymerization temperature of from 20° C. to 200° C.

It is also possible firstly to prepolymerize the preactivated catalyst system with alpha-olefins, or linear C₂-C₁₀-1-alkenes and in particular ethylene or propylene, and then to use the resulting prepolymerized catalyst solid in the actual polymerization. The mass ratio of catalyst solid used in the prepolymerization to monomer polymerized onto it is usually in the range from 1:0.1 to 1:2.

It is also possible to isolate the catalyst in the non-prepolymerized form or in the prepolymerized form and store it as a solid and re-suspend it on later use.

The catalysts systems of the disclosure are particularly suited for liquid phase polymerization process. In fact, the small average particle size of the component (A), such as less than 30 micrometers, or ranging from 5 to 20 micrometers, is particularly suited for slurry polymerization in an inert medium, which can be carried out continuously stirred tank reactor or in loop reactors. In one form the polymerization process is carried out in two or more cascade loops or stirred tank reactors producing polymers with different molecular weight and/or different composition in each reactor. In addition, to the ethylene homo and copolymers mentioned above the catalysts of the present disclosure are also suitable for preparing very-low-density and ultra-low-density polyethylenes (VLDPE and ULDPE, having a density lower than 0.920 g/cm³, to 0.880 g/cm³) consisting of copolymers of ethylene with one or more alpha-olefins having from 3 to 12 carbon atoms, having a mole content of units derived from ethylene of higher than 80%; elastomeric copolymers of ethylene and propylene and elastomeric terpolymers of ethylene and propylene with smaller proportions of a diene having a content by weight of units derived from ethylene of between about 30 and 70%.

Polyethylene Polymerization Product: The reaction product using the above described processes and catalyst is a polyolefin, preferably a polyethylene homopolymer or copolymer. The produced polyethylene can have a density from about 0.940 g/cm³ to about 0.970 g/cm³, a melt index from about greater than 0 to about 50 g/10 min, a particle size distribution of from about 50 to about 850 micrometers in diameter, wherein less than about 0.05 wt. % of the particles are 850 micrometers or larger and/or less than about 0.05 wt. % of the particles are 45 micrometers or less. Alternatively, or in addition, the produced polyethylene has a comonomer incorporation between greater than 0 and 5 butyl branches per 1000 carbons, and 0 for a homopolymer. In other embodiments, the produced polyethylene has a Mn range between 5-25 kg/mol, a Mw between 50 and 120 kg/mol, a Mz between 200 and 500 kg/mol, a Mw/Mn between 3 and 8, and a Mz/Mw range between 3 and 5.

The catalyst mileage for the above described Ziegler catalyst system is greater than 10 kg of produced polyethylene per g of catalyst (catalyst D₅₀ particle size between 5-20 micrometer and obtained powder bulk density greater than 0.370 g/cm³) in the above described loop-slurry reactor. This means that there will be a lower catalyst cost per unit of produced polymer.

### EXAMPLES

The following examples are included to demonstrate embodiments of the appended claims using the above-described processes and compositions. These examples are intended to be illustrative only, and not to unduly limit the scope of the appended claims. Those of skill in the art should appreciate that many changes can be made in the specific embodiments which are disclosed and still obtain a like or similar result without departing from the spirit and scope of the disclosure herein. In no way should the following examples be read to limit, or to define, the scope of the appended claims.

### Preparation of the Catalyst Use in Examples

114 g (1 mol) of commercial Mg(OC₂H₅)₂ were suspended in diesel oil (hydrogenated petroleum fraction having a boiling range of 140-170° C.) (total volume: 1.0 L). The suspension was converted into a dispersion in a cylindrical glass vessel under inert gas (Ar) to exclude moisture and air (O₂) using a high-speed stirrer (Ultra-Turrax®) with external cooling by means of an ice bath (time: about 8 hours). The dispersion had a gel-like consistency. A volume of 0.25 L containing 0.25 mol of Mg(OC₂H₅)₂ of the gel-like dispersion was transferred to a 1 L glass flask provided with reflux condenser, 2-blade blade stirrer and inert gas blanketing (Ar), and 0.25 L of diesel oil having a boiling range of 140-170° C. (hydrogenated petroleum fraction) was added and the mixture was stirred at room temperature for 10 minutes at a stirrer speed of 100 rpm.

This gel-like dispersion was brought to 85° C. while stirring at a stirrer speed of 250 rpm and 0.075 mol of TiCl₄ in 25 mL of diesel oil (hydrogenated petroleum fraction having a boiling range of 140-170° C.) was subsequently metered in over a period of 4 hours. After a post-reaction time of 0.5 hour, the suspension is cooled down to ambient temperature and the stirrer is switched off. After the solid had settled, the supernatant liquid phase (mother liquor) was taken off. The solid was subsequently re-suspended in fresh diesel oil (hydrogenated petroleum fraction having a boiling range from 140 to 170° C.) and after a stirring time of 15 minutes and subsequent complete settling of the solid, the supernatant liquid phase was taken off again. This washing procedure was repeated several times until titanium concentration of the supernatant liquid phase is below 10 mmol/L. Afterwards the mixture was heated to 85° C. Subsequently 0.0125 mol of titanium(IV) 2-ethylhexyloxide in 25 mL of diesel oil (hydrogenated petroleum fraction having a boiling range of 140-170° C.) was metered in over a period of 1 hour while stirring at a stirrer speed of 250 rpm. After a post-reaction time of 1 hour the suspension was heated to 110° C. Subsequently 0.175 mol of Al₂(C₂H₅)₃Cl₃ in 250 mL of diesel oil (hydrogenated petroleum fraction having a boiling range of 140-170° C.) was metered in over a period of 2 hours while stirring at a stirrer speed of 250 rpm. The temperature was subsequently held at 110° C. for a further 2 hours. Afterwards the suspension is cooled down to ambient temperature and the stirrer is switched off. After the solid had settled, the supernatant liquid phase (mother liquor) was taken off. The solid was subsequently resuspended in fresh diesel oil (hydrogenated petroleum fraction having a boiling range from 140 to 170° C.) and after a stirring time of 15 minutes and subsequent complete settling of the solid, the supernatant liquid phase was taken off again. This washing procedure was repeated several times until chlorine and titanium concentration of the supernatant liquid phase is below 10 mmol/L.

The molar ratio of the solid, catalyst component A, was Mg:Ti:Cl≈1:0.27:2.43. The titanium content of the solid catalyst component was 7.5 wt. %, =0.64 kg catalyst per mol titanium. The catalyst grain size for the examples was between 5 and 15 micrometers.

The results for the elemental composition of the catalysts described reported in the examples were obtained by the following analytical methods: Ti: photometrically via the peroxide complex; Mg, Cl: titrimetrically by customary methods.

### Bench Reactor Semi-Batch Polymerization

Bench scale polymerizations were carried out in 2 L total volume jacketed reactor equipped with a marine type impeller, water recirculation cascade heating system and a thermocouple. The reactor was conditioned by overpressure purging with high pressure nitrogen. This was followed by stabilizing the reactor temperature at 40° C. and the introduction of the triethylaluminium (TEAl) in n-hexane by pushing with approximately 0.7 L of isobutane feed. TEAl was used as scavenger and co-catalyst for the polymerization reaction. Hydrogen and 1-hexene as comonomer (when applicable) were fed subsequently. The temperature was then ramped up to 98° C. and the ethylene was added to the target total pressure of 450 psig. The desired mass of catalyst was suspended in n-hexane and transferred to a catalyst injection cylinder, which was then pressurized and pushed with approximately 0.1 L of isobutane to the reaction medium. The reactor pressure was maintained by constant feed of ethylene and the reaction temperature, pressure and ethylene uptake were then monitored and recorded.

### Loop-Slurry Polymerization

The catalyst disclosed above and in WO91/18934 was placed in a loop-slurry reactor to produce the presently disclosed polyethylene. The catalyst system performance was investigated in an industrial trial and the polymerization reaction was carried out at 650 psig in a 24-inch O.D. pipe, 728 feet long horizontal loop reactor, in which the reaction slurry was circulated at a velocity of 28 feet per second by means of axial-flow pump located in an elbow of the reactor. Polymerization reactions were carried out in an isobutane slurry, which ethylene concentration ranged between 6-8 mol %, temperature range of 92-98° C., with a residence time of between 30-52 min (depending upon the solid concentration in the loop-reactor 25-35 wt. %).

In some examples, a comonomer was polymerized with the ethylene, which the comonomer to ethylene molar ratio ranged between 0.003 to 0.007.

### Comparative CSTR Polymerization

The presently disclosure methods using loop-slurry reactors was compared with a catalyst performance in a continuous stirred-tank reactor (CSTR). In more detail, the polymerization trials were carried out using two CSTR reactors configures optionally in parallel or in series depending on the tested conditions. These reactors were equipped with an impeller stirrer and baffles. The temperature in the reactor was measured and automatically kept constant. The polymerization temperature ranged between 75-87° C. depending on the target product.

The polymerization reaction in the CSTR was carried out as follows:

n-Hexane was used as the process solvent in an 80 m³ working volume of both reactors. The catalyst component A prepared as described under a) was continuously fed into the first reactor in slurry form by means of a membrane pump by upward strokes. In these experiments Triethylaluminum (TEAl) was used as cocatalyst and fed into the reactor ratio to catalyst feed (Al/Ti molar ratio between 1-30). The process was operated continuously by feeding fresh process solvent, ethylene, comonomer (1-butene or 1-hexene) and hydrogen to the reactors. As indicated, the catalyst disclosed here is commercially available for use in Continuous Stir Tank Reactors (CSTR). Thus, the polymerization conditions are performed under lower temperature (75-87° C.), lower pressure (30-150 psig), longer residence time (90-180 min), and much lower ethylene molar fraction of the liquid phase composition in the reaction medium (under 1.5 mol %).

### Example 1

For Example 1, a comparison between industrial trials using the above described catalyst in a CSTR and loop-slurry reactor to produce a polyethylene copolymer was performed. As these were industrial trials, we were not able to obtain data using the same comonomer for both the CSTR and loop-slurry.

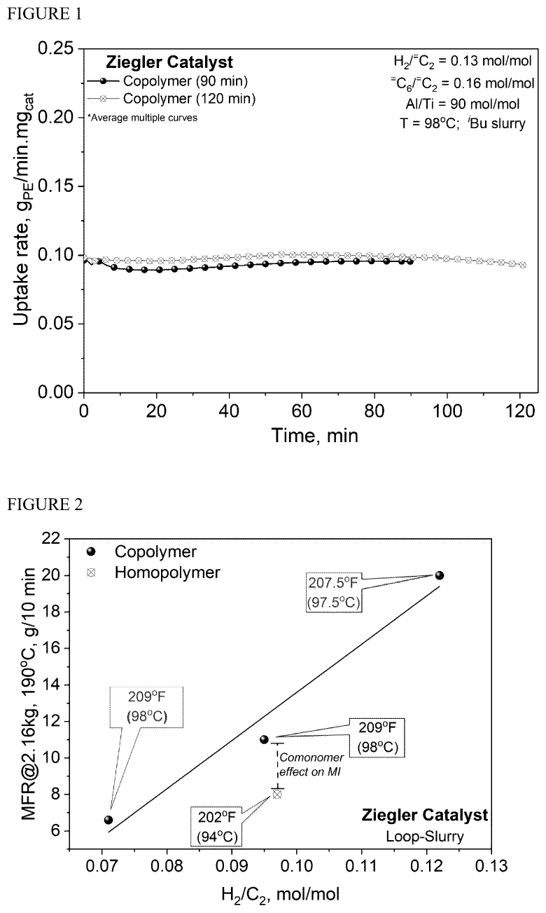

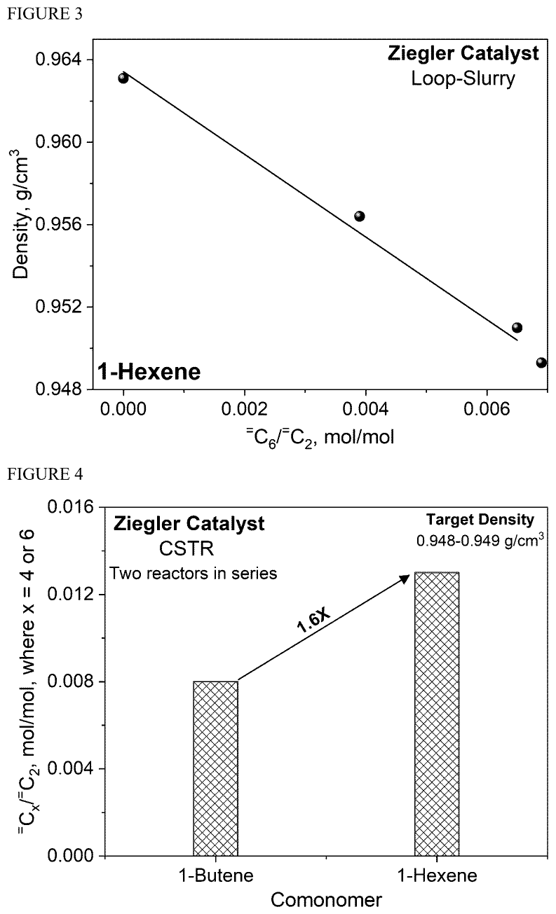

The hydrogen and comonomer response were evaluated for both industrial trials. Hydrogen and 1-hexene (^{═}C₆) comonomer response curves for the presently described loop-slurry polymerization conditions are shown in FIG. 2 and FIG. 3, and comparisons with the CSTR reactor are shown in Table 1.

In FIG. 2, an increasing mol ratio of hydrogen to ethylene resulted in a polyethylene with higher melt flow rate, while the catalyst maintains its high catalyst mileage greater than 10 kgPE/gcat.

The comonomer response is how much comonomer is needed in the reactor to obtain a certain density. As shown in FIG. 3, a mole ratio of 0.006 of hexene to ethylene resulted in a polyethylene copolymer with a density of about 0.950 g/cm³. In contrast, the CSTR needed an estimated mole ratio of 0.013 of hexene to ethylene to obtain a polyethylene copolymer with a density of about 0.948-0.949 g/cm³. This is an improvement of at least 2 times in the comonomer incorporation response when used under the loop-slurry polymerization conditions. Thus, under the loop-slurry conditions described above, significant improvement in the hexene comonomer response is observed with the catalyst disclosed herein.

TABLE 1
CSTR vs. Loop-Slurry comparison analysis.

| Process | CSTR | Loop-Slurry |
|---|---|---|
| C4/C2 (mol/mol) | 0.008 | — |
| C6/C2 (mol/mol) | 0.013* | 0.006 |
| Density (g/cm³) | 0.948-0.949 | 0.950 |

*Industrial trial using 1-hexene showed an increase of 1.5 times comonomer mol ratio to ethylene in reactor compared to 1-butene to reach the same density using two reactors in series.

FIG. 3 shows that, under unimodal loop-slurry conditions, 1-hexene incorporation is either better than or similar to 1-butene incorporation under unimodal CSTR reactor conditions. Therefore, the higher temperature and pressure of the loop-slurry process showed significant improvements in the rate of monomer transfer from the bulk slurry phase to the catalyst surface FIG. 4 shows that CSTR process needs approximately 1.6 times higher molar fraction of 1-hexene in a reactor compared to 1-butene to reach a similar density.

Additionally, regular particle morphology and high powder bulk density were maintained under the loop-slurry conditions. Under the loop-slurry polymerization conditions described above, catalyst mileage range between 10-15 kgPE/gcat. Additionally, the powder bulk density ranged between 0.42-0.51 g/cm³. Higher powder bulk density is desired for optimum powder discharge from loop reactor.

Thus, it was found that using this catalyst in the loop-slurry reactor required less comonomer to reach the same polyethylene density as the comparative CSTR reactor, with less residence time.

### Example 2

A series of additional industrial trials on the loop-slurry reactor using the catalyst disclosed herein were carried out to produce different polyethylene products. The loop-slurry reactor conditions that produced Products 1-4 are provided in Table 2, below.

TABLE 2
Loop Reactor Conditions for the Products of the Examples

| Parameters | Prod. 1 | Prod. 2 | Prod. 3 | Prod. 4 |
|---|---|---|---|---|
| Pressure, psig | 650 | 650 | 650 | 650 |
| Temperature, ° F. | 205.6 | 207.5 | 209 | 209 |
| Catalyst, PPH | 1.25 | 0.95 | 1.01 | 1.00 |
| TEAI, GPH | 5.0-6.0 | 3.5 | 3.5 | 3.5 |
| Ethylene, mol %^{a} | 5.5-6.5 | 5.5-6.5 | 5.5-6.5 | 5.5-6.5 |
| 1-Hexene, GPH | NA | 60-70 | 90-100 | 95-110 |
| Hydrogen, mol % | 0.56 | 0.67 | 0.52 | 0.30-0.40 |
| H₂/C₂, mol/mol | 0.097 | 0.122 | 0.095 | 0.071 |
| C₆/C₂, mol/mol | 0 | 0.0039 | 0.0065 | 0.0069 |
| Production Rate, MPPH | 28 | 29 | 29 | 29-30 |
| Solids, % | 25.0 | 25.0-28.0 | 28.0 | 28.0 |
| Residence time, min | 32 | 32-49 | 49 | 69 |
| Yield, g/g | 10,000 | 12,000 | 12,000 | 15,000 |

^{a}Additional 2 mol % due to change in configuration between loop-reactor and hydroclone.

Physical properties for the products are shown in Table 3.

TABLE 3
Properties for products produced using Loop-slurry reactor

| | Product 1 | Product 2 | Product 3 | Product 4 |
|---|---|---|---|---|
| Density (g/cm³) | 0.963 | 0.956 | 0.950 | 0.949 |
| MFR (2.16 kg) | 7.92 | 19.20 | 10.94 | 6.61 |
| MFR (21.6 kg) | 217 | 473 | 265.14 | 158 |
| FRR | 27.36 | 24.75 | 24.0 | 24.0 |
| Mn (kg/mol) | 12.3 | 12.2 | 15.4 | 17.8 |
| Mw (kg/mol) | 83.5 | 64.0 | 75 | 84.9 |
| Mz (kg/mol) | 315.1 | 256.9 | 260.2 | 287.3 |
| Mw/Mn | 6.78 | 5.23 | 4.87 | 4.76 |
| Mz/Mw | 3.77 | 4.01 | 3.47 | 3.38 |

MFR/190° C.: melt flow rate in accordance with ASTM D1238, nominal load=2.16 kg and test temperature=190° C.; Flow rate ratio in accordance with ASTM D1238 FRR21.6/216=(MIR21.6/190/MIR5/190);

Table 4 displays the particle size distribution for the products, as determined using the sieving method described in ASTM D1921-01.

TABLE 4
Particle Size for products produced using Loop-slurry reactor
determined using the sieving method described in ASTM D1921-01

| | | 850 | 250 | 180 | 45 | <45 |
|---|---|---|---|---|---|---|
| | Sample | micrometers | micrometers | micrometers | micrometers | micrometers |
| Product 1 | S1 | 0.00881 | 0.38263 | 0.39522 | 0.18502 | 0.02832 |
| | S2 | 0.00541 | 0.42664 | 0.42799 | 0.14334 | 0 |
| | S3 | 0.00672 | 0.42745 | 0.40112 | 0.16359 | 0.00112 |
| | S4 | 0.00829 | 0.46399 | 0.39834 | 0.12938 | 0 |
| | S5 | 0.01149 | 0.38467 | 0.41456 | 0.18697 | 0.0023 |
| Product 2 | S6 | 0.00824 | 0.52378 | 0.34242 | 0.12555 | 0 |
| | S7 | 0.00348 | 0.47125 | 0.39373 | 0.13153 | 0 |
| | S8 | 0.00587 | 0.6739 | 0.26393 | 0.0563 | 0 |
| | S9 | 0.00521 | 0.64525 | 0.2853 | 0.06424 | 0 |
| | S10 | 0.00468 | 0.69974 | 0.25299 | 0.0426 | 0 |
| Product 3 | S11 | 0.00 | 0.71319 | 0.2452 | 0.04225 | 0 |
| | S12 | 0.00 | 0.69882 | 0.19555 | 0.10519 | 0 |
| | S13 | 0.00 | 0.78808 | 0.17358 | 0.03782 | 0 |
| | S14 | 0.00 | 0.81279 | 0.1657 | 0.0186 | 0 |
| | S15 | 0.00 | 0.76427 | 0.19308 | 0.04035 | 0 |
| Product 4 | S16 | 0.00 | 0.79767 | 0.17287 | 0.03 | 0 |
| | S17 | 0.00 | 0.84633 | 0.13287 | 0.01733 | 0 |
| | S18 | 0.00 | 0.80849 | 0.16227 | 0.02523 | 0 |
| | S19 | 0.01 | 0.88151 | 0.09745 | 0.0155 | 0 |

Additionally, polymer particle sizes were also determined by small-angle static light scattering (SASLS) method and the results are summarized in Table 5.

TABLE 5
Polymer Particle Size for products produced using
Loop-slurry reactor determined using SASLS.

| | Sample | D₁₀, μm | D₅₀, μm | D₉₀, μm | Span |
|---|---|---|---|---|---|
| Product 1 | S1 | 147 | 274 | 510 | 1.32 |
| | S2 | 145 | 272 | 523 | 1.39 |
| | S3 | 146 | 267 | 505 | 1.34 |
| Product 2 | S6 | 148 | 275 | 502 | 1.29 |
| | S7 | 152 | 274 | 488 | 1.23 |
| | S8 | 160 | 274 | 468 | 1.12 |
| Product 3 | S11 | 181 | 310 | 535 | 1.14 |
| | S12 | 166 | 287 | 497 | 1.15 |
| | S13 | 171 | 299 | 527 | 1.19 |
| Product 4 | S16 | 194 | 343 | 619 | 1.23 |
| | S17 | 175 | 307 | 544 | 1.20 |
| | S18 | 160 | 286 | 511 | 1.23 |

All polyethylene products, the average particle size D₅₀ was between 250 and 350 micrometers without the formation of fines or large aggregates. The combination of small particle, high powder bulk density and good particle morphology (i.e. the absence of broken particles) is preferred to provide optimum powder discharge, low powder carry over in the recycling streams and efficient drying post-reaction. Further, having smaller polymer particle sizes allows for better and easier homogenization during of the polyethylene resins during extrusion as the particles are able to become fully molten.

Further, it was observed that less than 0.05 wt. % of fines (<45 micrometers) were produced, even at lower MI and higher catalyst mileage. This is supported by imaging with a scanning electron microscope (SEM). FIG. 6 displays SEM images for Product 1 and 4. No fines were observed, and the polymer particles' integrity is intact. Specifically, the particles do not have a cracked or broken surface. Rather, they have a granular particle and smooth surface as expected with the inclusion of the comonomer. Thus, we were able to make uniform, small polymer particles without large amounts of fines and after high catalyst mileage.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logic. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

Illustrative, non-exclusive examples of compositions and according to the present disclosure are presented in the following enumerated paragraphs. It is within the scope of the present disclosure that an individual step of a method recited herein, included in the following enumerated paragraphs, may additionally or alternatively be referred to as a “step for” performing the recited action.
PCT1. A polyethylene composition produced by a loop-slurry process, the process comprising contacting a feedstock comprising ethylene with a solid catalyst comprising a magnesium dihalide support containing a predominantly titanium trichloride species on its crystalline lattice derived by the reaction of magnesium alcoholates with tetravalent, halogen-containing compounds and one or more aluminum alkyl or aluminum alkyl halide components at a temperature of between about 90 to about 105° C. and a residence time of between about 30 to about 60 min, wherein the solid catalyst has a particle size (D₅₀) from about 5 to about 20 micrometers.
PCT2. The polyethylene composition of paragraph PCT1, wherein a catalyst component is obtained by a process comprising: (a) reacting in an inert hydrocarbon suspension medium a Mg(OR₁)(OR₂) compound, in which R₁ and R₂ are identical or different and are each an alkyl radical having 1 to 10 carbon atoms, with a tetravalent transition metal compound having at least a Metal-halogen bond, used in amounts such that the molar ratio metal/Mg is from 0.05 to 5, thereby obtaining a solid reaction product dispersed in a hydrocarbon slurry; (b) washing the solid reaction product dispersed in a hydrocarbon slurry with a liquid hydrocarbon; (c) contacting the washed solid reaction product obtained in (b) with a tetravalent titanium compound; and (d) contacting the product obtained in (c) with an organometallic compound of a metal of group 1, 2 or 13 of the Periodic Table.
PCT3. The polyethylene composition of paragraph PCT2, wherein the Mg(OR₁)(OR₂) compound is magnesium ethylate.
PCT4. The polyethylene composition of paragraphs PCT2 or PCT3, wherein the transition metal compound of step (a) is MXₘ(OR₄)₄₋ₘ, wherein M is titanium, R₄ is an alkyl radical having from 1 to 9, carbon atoms and X is a halogen atom, and m is from 1 to 4.
PCT5. The polyethylene composition of paragraphs PCT2-PCT4, wherein the reaction of the magnesium alkoxide with the tetravalent transition metal compounds is carried out at a temperature at from 50 to 140° C.
PCT6. The polyethylene composition of paragraphs PCT2-PCT5, wherein the tetravalent titanium compound used in step (c) has formula TiXₘ(OR₄)₄₋ₘ, wherein X and m have the same meaning as in paragraph PCT4.
PCT7. The polyethylene composition of paragraphs PCT2-PCT6, wherein the product coming from step (b) of paragraph PCT2, and the tetravalent titanium compound are contacted in a molar ratio of Ti/Mg ranging from 0.001 to 1.
PCT8. The polyethylene composition of paragraphs PCT2-PCT7, wherein the tetravalent transition metal compound used in step (a) and (c) of paragraph PCT2 is TiCl₄.
PCT9. The polyethylene composition of paragraphs PCT2-PCT8, wherein the solid reaction product of step (c) of paragraph PCT2 is contacted with an organometallic compound chosen among organoaluminum compounds.
PCT10. The polyethylene composition of paragraphs PCT2-PCT9, wherein the organometallic compound is a chlorine-containing organoaluminum compounds.
PCT11. The polyethylene composition of paragraphs PCT2-PCT10, wherein after completion of step (d) of paragraph PCT2 the solid catalyst component is contacted with a silicon compound of formula R^{I}ₐR^{II}_{b}Si(OR^{III})_{4-(a+b)} where R^{I}-R^{III} are linear, branched, cyclic or aromatic C₁-C₂₀ hydrocarbon groups, a and b are integers from 0 to 2 with the proviso that (a+b) ranges from 1 to 3.
PCT12. The polyethylene composition of any of paragraphs PCT1-PCT11, wherein the polyethylene composition is HDPE.
PCT12. The polyethylene composition of any of paragraphs PCT1-PCT11, wherein the median particle size (D₅₀) of the polyethylene is between 200 and 400 micrometer.
PCT13. The polyethylene composition of any of paragraphs PCT1-PCT12, wherein the polyethylene has a powder bulk density is greater than 0.350 g/cm³.
PCT14. The polyethylene composition of any of paragraphs PCT1-PCT13, wherein the feedstock further comprises at least one alpha-olefin with from 3 to 10 carbons atoms.
PCT15. The polyethylene composition of any of paragraphs PCT1-PCT14, wherein the polyethylene composition has at least one of the following properties: (a) density from about 0.930 g/cm³ to about 0.970 g/cm³; (b) a melt index from about 1 to about 25 g/min; (c) a particle size distribution of 50 to 850 micrometers, wherein less than 0.04 wt. % of the particles are less than 45 micrometers in diameter; (d) a Mn range between 5-25 kg/mol; (e) a Mw between 50 and 120 kg/mol; (f) an Mz between 200 and 500 kg/mol; (g) a Mw/Mn between 3 and 8; and/or, (h) a Mz/Mw range between 3 and 5.
PCT16. A loop-slurry process comprising contacting a feedstock comprising ethylene with a solid catalyst comprising a magnesium dihalide support containing a predominantly titanium trichloride species on its crystalline lattice derived by the reaction of magnesium alcoholates with tetravalent, halogen-containing compounds and one or more aluminum alkyl or aluminum alkyl halide components at a temperature of between about 90 to about 105° C. and a residence time of between about 30 to about 60 min.
PCT17. The loop-slurry process of paragraph PCT16, wherein a catalyst component is obtained by a process comprising: (a) reacting in an inert hydrocarbon suspension medium a Mg(OR₁)(OR₂) compound, in which R₁ and R₂ are identical or different and are each an alkyl radical having 1 to 10 carbon atoms, with a tetravalent transition metal compound having at least a Metal-halogen bond, used in amounts such that the molar ratio metal/Mg is from 0.05 to 5, thereby obtaining a solid reaction product dispersed in a hydrocarbon slurry; (b) washing the solid reaction product dispersed in a hydrocarbon slurry with a liquid hydrocarbon; (c) contacting the washed solid reaction product obtained in (b) with a tetravalent titanium compound, and (d) contacting the product obtained in (c) with an organometallic compound of a metal of group 1, 2, or 13 of the Periodic Table.
PCT18. The loop-slurry process of paragraph PCT17, wherein the Mg(OR₁)(OR₂) compound is magnesium ethylate.
PCT19. The loop-slurry process of paragraphs PCT17 or PCT18, wherein the transition metal compound of step (a) is MXₘ(OR₄)₄₋ₘ, wherein M is titanium, R₄ is an alkyl radical having from 1 to 9, carbon atoms and X is a halogen atom, and m is from 1 to 4.
PCT20. The loop-slurry process of any of paragraphs PCT17 to PCT19, wherein the reaction of the magnesium alkoxide with the tetravalent transition metal compounds is carried out at a temperature of from 50 to 140° C.
PCT21. The loop-slurry process of claim catalyst component according to any of paragraphs PCT17 to PCT20, wherein the tetravalent titanium compound used in step (c) has formula TiXₘ(OR₄)₄₋ₘ, wherein X is a halogen atom, and m is from 1 to 4.
PCT22. The loop-slurry process of catalyst component according to any of paragraphs PCT17 to PCT21, wherein the product coming from step (b) and the tetravalent titanium compound are contacted in a molar ratio of Ti/Mg ranging from 0.001 to 1.
PCT23. The loop-slurry process of any of paragraphs PCT17 to PCT22, wherein the tetravalent transition metal compound used in step (a) and (c) is TiCl₄.
PCT24. The loop-slurry process of any of paragraphs PCT17 to PCT23, wherein the solid reaction product of step (c) is contacted with an organometallic compound chosen among organoaluminum compounds.
PCT25. The loop-slurry process of any of paragraphs PCT17 to PCT24, wherein the organoaluminum compounds are chlorine-containing organoaluminum compounds.
PCT26. The loop-slurry process of any of paragraphs PCT17 to PCT25, the temperature is between about 92 to about 98° C. and a residence time of between about 30 to about 52 min.

### INDUSTRIAL APPLICABILITY

The systems and methods disclosed herein are applicable to the plastics industry. It is believed that the disclosure set forth above encompasses multiple distinct inventions with independent utility. While each of these inventions has been disclosed in a preferred form, the specific forms thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A polyethylene composition produced by a loop-slurry process, the process comprising contacting a feedstock comprising ethylene with a solid catalyst comprising a magnesium dihalide support containing a predominantly titanium trichloride species on its crystalline lattice derived by the reaction of magnesium alcoholates with tetravalent, halogen-containing compounds and one or more aluminum alkyl or aluminum alkyl halide components at a temperature of between about 90 to about 105° C. and a residence time of between about 30 to about 60 min, wherein the solid catalyst has a particle size (D₅₀) of about 5 to about 20 micrometer.

2. The polyethylene composition of claim 1, wherein the median particle size (D₅₀) of the polyethylene is between 200 and 400 micrometer.

3. The polyethylene composition of claim 1, wherein said polyethylene has a powder bulk density is greater than 0.350 g/cm³.

4. The polyethylene composition of claim 1, wherein said feedstock further comprises at least one alpha-olefin with from 3 to 10 carbons atoms.

5. The polyethylene composition of claim 1, wherein the polyethylene composition has at least one of the following:
(a) density from about 0.930 g/cm³ to about 0.970 g/cm³;
(b) a melt index from about 1 to about 25 g/min;
(c) a particle size distribution of 50 to 850 micrometers, wherein less than 0.04 wt. % of the particles are less than 45 micrometers in diameter;
(d) a Mn range between 5-25 kg/mol;
(e) a M_{w} between 50 and 120 kg/mol;
(f) an M_{z} between 200 and 500 kg/mol;
(g) a M_{w}/Mₙ between 3 and 8;
(h) a M_{z}/M_{w} range between 3 and 5, and/or,
(i) a D₅₀ between 200 and 400 micrometers.

6. The polyethylene composition of claim 1, wherein the temperature is between about 92 to about 98° C. and a residence time of between about 30 to about 52 min.

7. The polyethylene composition of claim 1, wherein a catalyst component is obtained by a process comprising:
(a) reacting in an inert hydrocarbon suspension medium a Mg(OR₁)(OR₂) compound, in which R₁ and R₂ are identical or different and are each an alkyl radical having 1 to 10 carbon atoms, with a tetravalent transition metal compound having at least a Metal-halogen bond, used in amounts such that the molar ratio metal/Mg is from 0.05 to 5, thereby obtaining a solid reaction product dispersed in a hydrocarbon slurry;
(b) washing the solid reaction product dispersed in a hydrocarbon slurry with a liquid hydrocarbon;
(c) contacting the washed solid reaction product obtained in (b) with a tetravalent titanium compound; and
(d) contacting the product obtained in (c) with an organometallic compound of a metal of group 1, 2 or 13 of the Periodic Table.

8. The polyethylene composition of claim 7, wherein the Mg(OR₁)(OR₂) compound is magnesium ethylate.

9. The polyethylene composition of claim 7, wherein the transition metal compound of step (a) is MXₘ(OR₄)₄₋ₘ, wherein M is titanium, R₄ is an alkyl radical having from 1 to 9, carbon atoms and X is a halogen atom, and m is from 1 to 4.

10. The polyethylene composition of claim 8, wherein the reaction of the magnesium alkoxide with the tetravalent transition metal compounds is carried out at a temperature at from 50 to 140° C.

11. The polyethylene composition of claim 7, wherein the tetravalent titanium compound used in step (c) has formula TiXₘ(OR₄)₄₋ₘ, wherein X is a halogen atom, and m is from 1 to 4.

12. The polyethylene composition of claim 11, wherein the product coming from step (b) and the tetravalent titanium compound are contacted in a molar ratio of Ti/Mg ranging from 0.001 to 1.

13. The polyethylene composition of claim 7, wherein the tetravalent transition metal compound used in step (a) and (c) is TiCl₄.

14. The polyethylene composition of claim 7, wherein the solid reaction product of step (c) is contacted with an organometallic compound chosen among organoaluminum compounds.

15. The polyethylene composition of claim 14, wherein the organoaluminium compounds are chlorine-containing organoaluminum compounds.

16. The polyethylene composition of claim 7, wherein after completion of step (d) the solid catalyst component is contacted with a silicon compound of formula R^{I}ₐR^{II}_{b}Si(OR^{III})_{4-(a+b)} where R^{I}-R^{III} are linear, branched, cyclic or aromatic C₁-C₂₀ hydrocarbon groups, a and b are integers from 0 to 2 with the proviso that (a+b) ranges from 1 to 3.
